(19) United States
(12) Patent Application Publication
(10) Pub. No.: US 2006/0023903 A1
(43) Pub. Date: Feb. 2, 2006

(54) Coaxial speaker including support member having hollow to function as back cavity

(75) Inventors: Shigeru Hayashi, Shizuoka (JP); Masatoshi Miyashita, Shizuoka (JP)

Correspondence Address: FOLEY AND LARDNER LLP;SUITE 500, 3000 K STREET NW, WASHINGTON, DC, 20007, US

(73) Assignee: MINEBEA CO., LTD.

(21) Appl. No.: 11/189,823

(22) Filed: Jul. 27, 2005

(30) Foreign Application Priority Data
Jul. 27, 2004 (JP) 2004-218574

(51) Int. Cl. H04R 25/00

(52) U.S. Cl. 381/182

(57) ABSTRACT

A coaxial speaker includes: a woofer including a center pole; a tweeter including a diaphragm, a frame to hold an outer circumference of the diaphragm, a dust cap attached to the diaphragm, and components constituting a magnetic circuit; and a support member disposed between the center pole of the woofer and the tweeter. The support member has a hollow that is communicated with an enclosed space present behind the diaphragm of the tweeter via at least one passage.

### BACKGROUND OF THE INVENTION

1. Field of the Invention

The present invention relates to a speaker for use in various audio equipments, and more particularly to a coaxial speaker with an enhanced reproduction frequency characteristic so as to achieve a smooth transition between woofer sound output and tweeter sound output.

2. Description of the Related Art

In many of car-mounted audio systems, what is called “a coaxial speaker” is employed to make efficient use of a limited space in a door or a rear tray. The coaxial speaker has multiple speakers arranged coaxially with each other and is structured, for example, such that a tweeter as a high frequency speaker is disposed in front of a woofer as a low frequency speaker with a support member therebetween. The woofer and the tweeter have the same acoustical center, which tends to concentrate their sound sources thereby producing a coherent sound output and also enabling a compact design.

One type of coaxial speaker is disclosed in, for example, Japanese Utility Model Application Laid-Open No. H5-25896. In the coaxial speaker, a center pole of a yoke of a woofer has, along its axis, a through-hole which has upper and lower annular countersunk steps respectively formed along the circumference of both ends thereof, and a support member has a fitting portion which sits at the upper countersunk step, and which has a protrusion to fit into the through-hole and also has a slit claw portion adapted to stretch outward by a head of an attaching screw so as to be engaged with the lower annular countersunk step.

Another type of coaxial speaker is disclosed in, for example, Japanese Patent Application Laid-Open No. H6-269075. In the coaxial speaker, a support member is disposed at a yoke of a woofer, a fitting groove and an engagement groove are formed at the top end of the support member, a trunk terminal for an input signal is provided at the support member, a hook portion is provided at a yoke of a tweeter, a taper portion is formed at one face of the hook portion, an input terminal is provided at a frame, and the tweeter is fixedly attached to the woofer such that the taper portion of the tweeter is pressed into the engagement groove of the woofer and the tweeter is rotated while the input terminal is fitted in a substantially U-shaped portion of the trunk terminal.

Still another type of coaxial speaker is disclosed in, for example, Japanese Patent Application Laid-Open No. H7-322385. In the coaxial speaker, a support member is provided at a yoke of a woofer, and a tweeter is disposed in front of the woofer with the support member therebetween, wherein the tweeter has an elliptic diaphragm which has its center axis positioned at or near the center axis of the woofer diaphragm.

It is well know that in the conventional axial speakers described above, mid-range characteristic is disturbed by attaching a spacer member. In order to deal with this problem, in a coaxial speaker disclosed in Japanese Patent Application Laid-Open No. H5-95595, a spacer member adapted to suppress rise in the sound pressure level in the mid-to-high frequency range is provided thereby preventing deterioration in sound quality. Specifically, a resonator is provided at a portion of a spacer used for attaching a tweeter or a mid-high range speaker to a woofer in a coaxial manner. The resonant frequency of the spacer can be adjusted easily by changing the volume of the spacer, or modifying the configuration or number of the ports of the spacer, and the Q-factor can be adjusted by putting sound absorbing materials inside the resonator. Further, the resonator, when divided into several sections having respective resonant frequencies different from one another, causes the sound pressure in the mid-high range to be lowered across an extensive band. The spacer includes a head portion and a trunk portion and is structured such that a recess formed at the bottom end of the head portion is engaged with and bonded to a flange formed at the top end of the trunk portion, a cavity is defined by the flange, and that a plurality of ports are formed in the flange so as to continuous with the cavity, and the resonator is constituted by the cavity and the ports.

As described above, the coaxial speaker disclosed in the aforementioned Japanese Patent Application Laid-Open No. H5-95595 features the spacer which serves its function without causing distortion in the mid-range characteristic, specifically which suppresses rise in the sound pressure level in the mid-high frequency range in order to prevent deterioration in sound quality. In this coaxial speaker, however, a back cavity of the tweeter, that is, a spatial volume present behind a diaphragm of the tweeter is decreased. Consequently it becomes difficult to damp the resonance of the vibration system, and Qts representing the Q-factor at a resonant frequency f₀, which is inversely proportional to a value of the cavity, will tend to increase. Accordingly, an output with a prominent value occurs near the frequency f₀, which result in stressing a sound at a given frequency thus failing to provide a smooth reproduction frequency characteristic. Thus, the coaxial speaker is not freed from a poor transition between the woofer sound and the tweeter sound and from reproduction of distorted sound.

### SUMMARY OF THE INVENTION

The present invention has been made in light of the above circumstance and has as an object to provide a coaxial speaker which has its reproduction frequency characteristic enhanced for an improved transition between a woofer sound and a tweeter sound.

In order to achieve the object described above, according to an aspect of the present invention, there is provided a coaxial speaker which includes: a woofer including a center pole; a tweeter including a diaphragm, a frame to hold an outer circumference of the diaphragm, a dust cap attached to the diaphragm, and components constituting a magnetic circuit; and a support member disposed between the center pole of the woofer and the tweeter. The support member has a hollow that is communicated with an enclosed space present behind the diaphragm of the tweeter.

In the aspect of the present invention, the enclosed space may be defined by the diaphragm, the frame, the dust cap, and the components of the magnetic circuit.

In the aspect of the present invention, the magnetic circuit is either an inner magnet structure or an outer magnet structure.

In the aspect of the present invention, the hollow may be communicated with the enclosed space via at least one passage formed through the components of the magnetic circuit.

In the aspect of the present invention, the hollow may be communicated with the enclosed space via at least one passage including a recess formed at an inner circumferential surface of the support member and a recess formed at an inner circumferential surface of the frame.

In the aspect of the present invention, the support member may have a cup-like configuration having an open end.

In the aspect of the present invention, the support member and the frame may be integrated as one piece such that the frame is integrally attached to the open end of the support member.

In the aspect of the present invention, a wire housing portion extending in an axial direction for accommodating wires connecting between the woofer and the tweeter may be provided inside the support member so as to be completely partitioned off from the hollow in order to keep the hollow hermetic.

In the aspect of the present invention, the at least one passage may be located in a center portion of the magnetic circuit.

In the aspect of the present invention, the recess of the support and the recess of the frame may be aligned along an axial direction.

Accordingly, since the enclosed space existing behind the diaphragm of the tweeter is communicated, via at least one passage, with the hollow of the support member to fix the tweeter to the woofer, the hollow can serve to function as a back cavity of the tweeter thus significantly increasing the volume of the back cavity, which results in a smoother reproduction frequency characteristic and in improvement of an aggregate frequency characteristic of a tweeter and a woofer.

Especially, an optimum aggregate frequency characteristic can be achieved by appropriately setting the volume of the hollow of the support member in accordance with the application or size of the speaker.

Also, the integration of the support member and the tweeter frame eliminates the process of connecting both components and at the same time reduces the number of components, which leads to cost reduction.

And, the provision of the wire housing portion inside the support member allows the speaker wires to be installed efficiently and neatly.

### BRIEF DESCRIPTION OF THE DRAWINGS

FIG. 1 is a cross sectional view of a coaxial speaker according to a first embodiment of the present invention;

FIG. 2 is a cross sectional view of a coaxial speaker according to a second embodiment of the present invention;

FIG. 3 is a cross sectional view of a coaxial speaker according to a third embodiment of the present invention;

FIG. 4 is a cross sectional view of a coaxial speaker according to a fourth embodiment of the present invention;

FIG. 5 is a cross sectional view of a coaxial speaker according to a fifth embodiment of the present invention;

FIG. 6 is a cross sectional view of a coaxial speaker according to a sixth embodiment of the present invention;

FIG. 7 is a cross sectional view of a coaxial speaker according to a seventh embodiment of the present invention;

FIG. 8 is a cross sectional view of a coaxial speaker according to a eighth embodiment of the present invention;

FIG. 9 is a cross sectional view of a coaxial speaker according to a ninth embodiment of the present invention;

FIG. 10 is an enlarged view of a relevant portion of the coaxial speaker of FIG. 9;

FIG. 11 is a graph of a frequency characteristic of a tweeter in the present invention; and

FIG. 12 is a graph of an aggregate frequency characteristic of woofer and tweeter in the present invention.

### DETAILED DESCRIPTION OF THE PREFERRED EMBODIMENTS

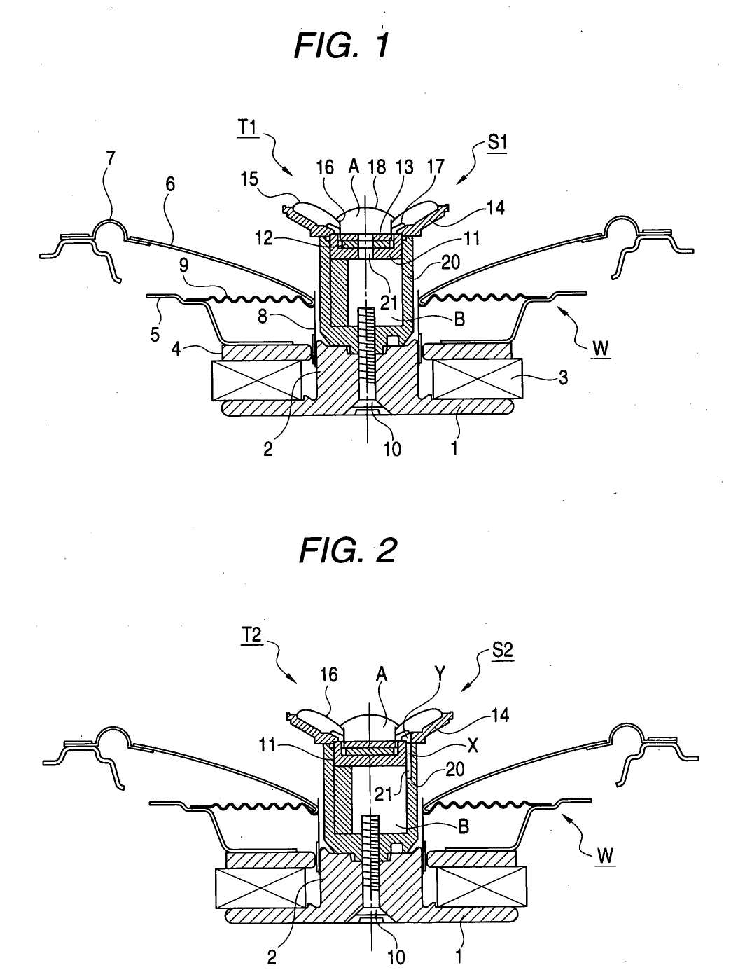

Preferred embodiments of the present invention will hereinafter be described with reference to the accompanying drawings, wherein same elements are denoted by same numerals. Referring to FIG. 1, a coaxial speaker S1 according to a first embodiment of the present invention includes a woofer W and a tweeter T1 disposed coaxial with the woofer W.

The woofer W includes a bottom plate 1, a center pole 2, a ring-like magnet 3, and a top plate 4. The center pole 2, the magnet 3, and the top plate 4 are fixedly disposed coaxially on the bottom plate 1, thus constituting a magnetic circuit. A frame 5 is disposed on the top plate 4, and a diaphragm 6 has its outer circumference attached to the front circumference of the frame 5 via a surround 7. A voice coil assembly 8 is attached to the inner circumference of the diaphragm 6 and is held by a spider 9 within a gap of the magnetic circuit.

The tweeter T1 includes a yoke 11 shaped like a pot, a ring-like magnet 12, and a plate 13. The magnet 12 and the plate 13 are fixedly disposed coaxially inside the yoke 11, thus constituting a magnetic circuit. A frame 14 is attached to the open end of the yoke 11, and a diaphragm 15 has its outer circumference attached to the front circumference of the frame 14. A voice coil assembly 16 is attached to the inner circumference of the diaphragm 15 and is held by a spider 17 within a gap of the magnetic circuit. The tweeter T1 further includes a dust cap 18. An enclosed space A is present behind the diaphragm 15. Specifically, the enclosed space A is defined by the frame 14, the diaphragm 15, the dust cap 18, and the magnetic circuit.

The tweeter T1 thus structured is attached to the woofer W in a coaxial manner such that the yoke 11 of the tweeter T1 is engaged with and bonded to an open end of a cup-like support member 20 fixed to the center of the center pole 2 by a screw 10. The support member 20 defines a hollow B communicated with the aforementioned enclosed space A via a passage 21 formed at the center portion of the magnetic circuit of the tweeter T1, specifically formed through the center portions of the yoke 11, the magnet 12, and the plate 13.

In such a tweeter T1 with a magnetic circuit of an inner magnet structure, since the hollow B of the support member 20 to fixedly attach the tweeter T1 can serve as a back cavity of the tweeter T1 thus providing a large back cavity, the value of Qts is decreased and the resonance is duly damped.

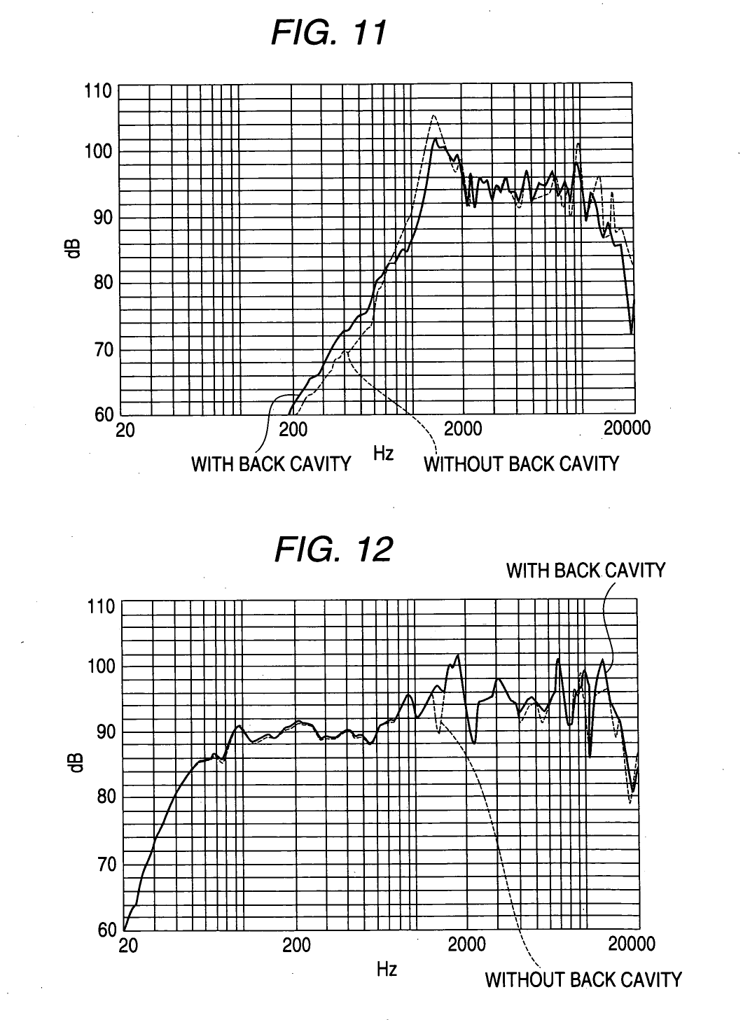

Referring to FIG. 11, it is shown the peak value in the frequency characteristic near the resonant frequency f₀ is suppressed. Consequently, as seen from FIG. 12 showing an aggregate frequency characteristic of the woofer W and the tweeter T1, the transition between the sounds of the woofer W and the tweeter T1 at the crossover frequency (around 1.5 kHz) is smoothed. Thus, in the coaxial speaker S1 according to the first embodiment, it is prevented from happening that sound at a given frequency is stressed. Consequently a high fidelity sound with a low distortion is reproduced.

Referring now to FIG. 2, a coaxial speaker S2 according to a second embodiment of the present invention differs from the coaxial speaker SI shown in FIG. 1 only in the structure of a tweeter T2, where a plurality of passages 21, rather than one single passage, are provided which communicate an enclosed space A with a hollow B of a support member 20. The plurality of passages 21 each include a recess X formed at the inner circumferential surface of the support member 20 located toward the open end thereof, and a recess Y formed at the inner circumference of a frame 14 so as to be aligned with the recess X. The coaxial speaker S2 achieves the same advantages and effects as the coaxial speaker S1.

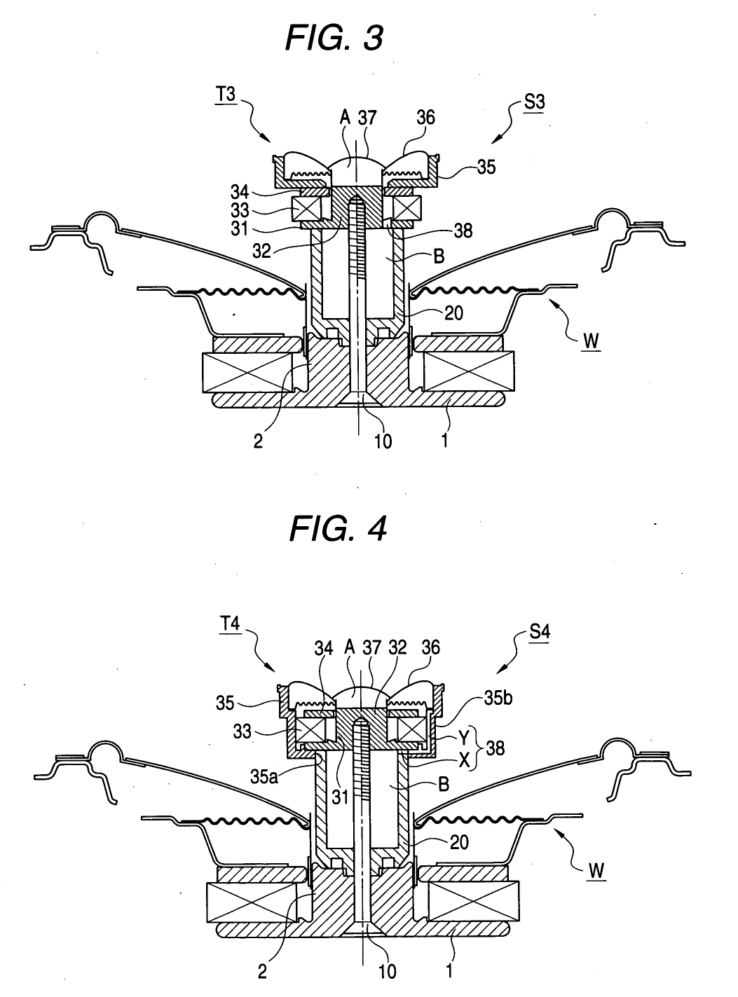

Referring to FIG. 3, a coaxial speaker S2 according to a third embodiment of the present invention includes a tweeter T3 with a magnetic circuit of an outer magnet structure, where the magnetic circuit includes a bottom plate 31 having a center pole 32, a magnet 33, and a top plate 34, all of which are arranged coaxially with one another. The bottom plate 31 is disposed at the open end of a support member 20 shaped like a cup, the support member 20 is disposed on a center pole 2 of a woofer W, and the woofer W, the support member 20, and the tweeter T3 are put together in a coaxial manner by a screw 10 protruding from the bottom surface of the bottom plate 1.

In the tweeter T3, an enclosed space A is defined by the bottom plate 31 with the center pole 32, the magnet 33, and the top plate 34, and further by a frame 35, a diaphragm 36, and a dust cap 37. Since the enclosed space A is communicated with a hollow B of the support member 20 via a plurality of passages 38 formed at the bottom plate 31, the hollow B serves to function as a back cavity of the tweeter T3. Thus, in the coaxial speaker S3 according to the third embodiment, it is prevented from happening that sound at a given frequency is stressed. Consequently a high fidelity sound with a low distortion is reproduced in the same way as in the coaxial speaker S1 shown in FIG. 1.

In connection with the third embodiment, though not illustrated, if the support member 20 and the tweeter T3 are previously fixed to each other, for example, by means of adhesive, then the screw 10 does not have to be threaded into the bottom plate 31 and the center pole 32 for fixation, and therefore the length of the screw 10 can be reduced like in the coaxial speaker S1 shown in FIG. 1 while the same advantages and effects can be achieved as in the coaxial speaker S3 shown in FIG. 3, and the reduction in the length of the screw 10 allows the center of the center pole 32 of the tweeter T3 to accommodate a through-hole which functions as a passage and replaces the plurality of passages 38.

Referring to FIG. 4, a coaxial speaker S4 according to a fourth embodiment of the present invention differs from the coaxial speaker S3 shown in FIG. 3 in the structure of a tweeter T4, where a frame 35 includes a hollow-cylinder portion 35b with a bottom 35a having an opening, and a magnetic circuit of an outer magnet structure, which includes a bottom plate 31 with a center pole 32, a magnet 33, and a top plate 34 arranged coaxially with one another, is housed inside the hollow-cylinder portion 35b of the frame 35.

In the coaxial speaker S4 described above, an enclosed space A is communicated with and a hollow B of a support member 20 via a plurality of passages 38 which each include a recess X formed at the open end of the support member 20, and a recess Y formed at the inner circumferential surfaces of the hollow-cylinder portion 35b and the bottom 35a so as to be aligned with the recess X. Thus, the hollow B of the support member serves to function as a back cavity of the tweeter T4.

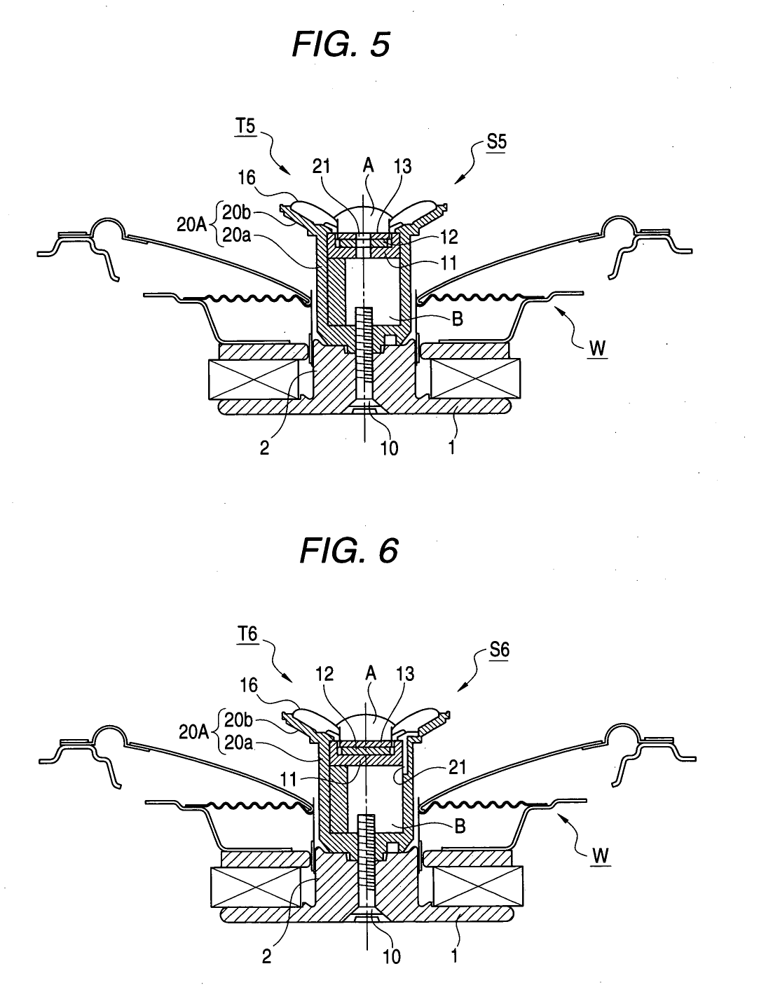

Referring to FIG. 5, a coaxial speaker S5 according to a fifth embodiment of the present invention differs from the coaxial speaker S1 shown in FIG. 1 in that in a tweeter T5, a support member and a frame are integrated as one piece. Specifically, the tweeter T5 is provided with an integrated member 20A which includes a support portion 20a shaped like a cup and serving to function as a support member, and a frame portion 20b attached integrally to the open end of the support portion 20a and serving to function as a frame, and a plate 13 is fixedly disposed inside the open end of the support portion 20a. In the coaxial speaker S5, the work of attaching a tweeter and a support member together is eliminated thus making the assembly work easier, and also the number of components is reduced.

Referring to FIG. 6, a coaxial speaker S6 according to a sixth embodiment of the present invention differs from the coaxial speaker S2 shown in FIG. 2 in that a tweeter T6 is provided with an integrated member 20A which integrally includes a support portion 20a serving to function as a support member and a frame portion 20b serving to function as a frame, and that a magnetic circuit, which include a yoke 11, a magnet 12, and a plate 13, is fixedly disposed inside the open end of the support portion 20a. Here, the difference from the coaxial speaker S5 shown in FIG. 5 is that an enclosed space A is communicated with a hollow B via a plurality of passages 21 each including a recess formed at the inner circumferential surface of the integrated member 20A in the coaxial speaker S6 while in the coaxial speaker S5, an enclosed space A is communicated with a hollow B via one single passage 21 formed through the center portion of a magnetic circuit.

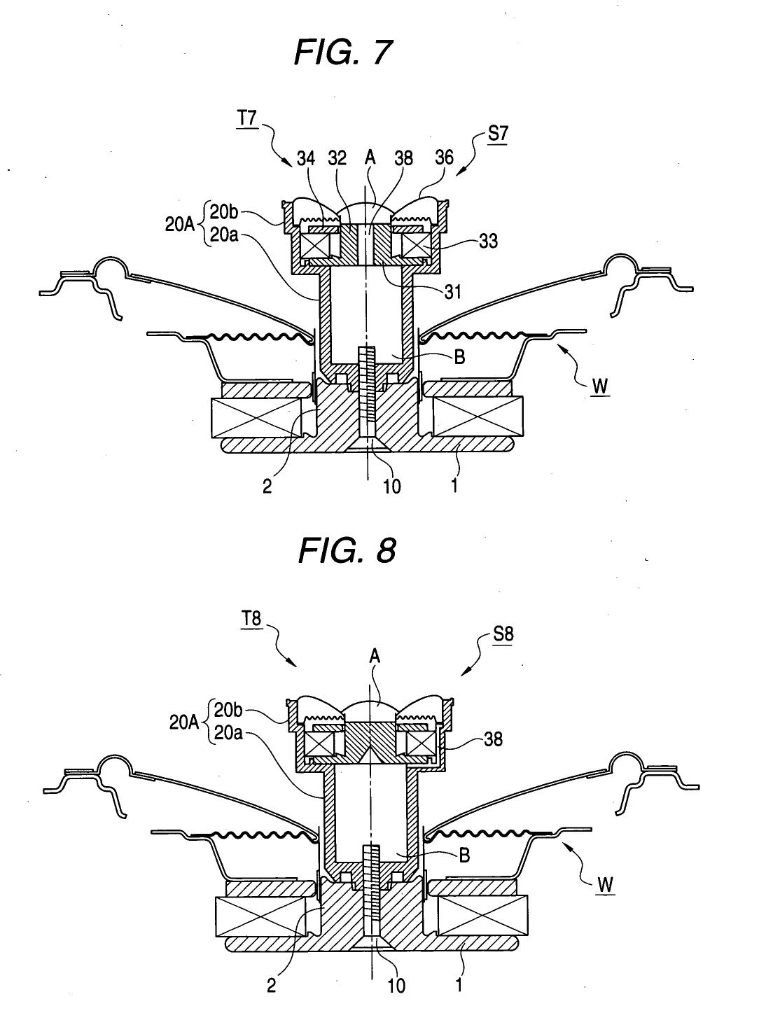

Referring to FIG. 7, a coaxial speaker S7 according to a seventh embodiment of the present invention differs from the coaxial speaker S3 shown in FIG. 3 in that a tweeter T7 includes an integrated member 20A which integrally includes a frame portion 20a serving to function as a frame and a support portion 20b serving to function as a support member, and a magnetic circuit including a bottom plate 31, a magnet 33, and a top plate 34 is fixedly disposed inside the open end of the support portion 20a. In the coaxial speaker S7, the integrated member 20A is fixedly attached to a center pole 2 of a woofer W by a screw 10 which is shorter than the screw 10 of the coaxial speaker S3, and an enclosed space A is communicated with a hollow B via a single passage 38 formed through the center of a center pole 32.

Referring to FIG. 8, a coaxial speaker S8 according to an eighth embodiment of the present invention differs from the coaxial speaker S4 shown in FIG. 4 in that a tweeter T8 includes an integrated member 20A which integrally includes a support portion 20a serving to function as a support member and a frame portion 20b serving to function as a frame, and a magnetic circuit of an outer magnet structure is fixedly disposed inside the open end of the support portion 20a. In the coaxial speaker S7, the integrated member 20A is fixedly attached to a center pole 2 of a woofer W by a screw 10 which is shorter than a screw 10 of the coaxial speaker S4, and an enclosed space A is communicated with a hollow B via a plurality of passages 38 each including a recess formed at the inner circumferential surface of the integrated member 20A.

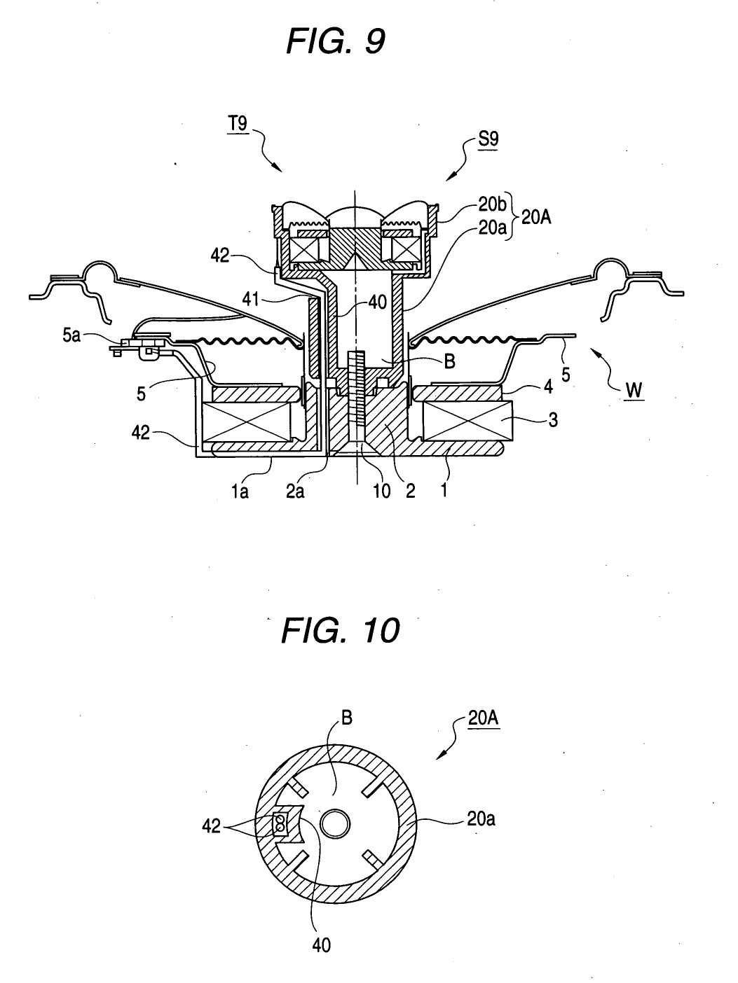

Referring to FIG. 9 and also FIG. 10, a coaxial speaker S9 according to a ninth embodiment of the present invention differs from the coaxial speaker S8 shown in FIG. 8 in that a wire housing portion 40 extending in the axial direction is formed at a part of the inner circumferential surface of a support portion 20a of an integrated member 20A so as to be partitioned off from a hollow B. The wire housing portion 40 has an opening 41 at its upper end and another opening at its lower end. Speaker wires 42 coming from a terminal plate of a tweeter T9 creep along the outer surface of a frame portion 20b of the integrated member 20A, enter from the opening 41 to go through the wire housing portion 40, exit out from the another opening, go through a groove 2a formed at a center pole 2a of a woofer W and a groove la formed at a bottom plate 1 of the woofer W, and are connected to a terminal plate 5a of a frame 5 of the woofer W, thus the speaker wires 42 can be installed neatly. In this connection, in a coaxial speaker, speaker wires may conventionally be housed in a hollow of a support member, but such a structure does not allow the hollow to serve as a back cavity due to the existence of openings for taking in and out the wires. In the ninth embodiment, the wire housing portion 40 is completely partitioned off from the hollow B, and therefore a hermetic back cavity is readily achieved.

While the present invention has been illustrated and explained with respect to specific embodiments thereof, it is to be understood that the present invention is by no means limited thereto but encompasses all changes and modifications that will become possible within the scope of the appended claims.

What is claimed is:

1. A coaxial speaker comprising:
a woofer comprising a center pole;
a tweeter comprising a diaphragm, a frame to hold an outer circumference of the diaphragm, a dust cap attached to the diaphragm, and components constituting a magnetic circuit; and
a support member disposed between the center pole of the woofer and the tweeter, and having a hollow, wherein the hollow is communicated with an enclosed space present behind the diaphragm of the tweeter.

2. A coaxial speaker according to claim 1, wherein the enclosed space is defined by the diaphragm, the frame, the dust cap, and the components of the magnetic circuit.

3. A coaxial speaker according to claim 2, the magnetic circuit is one of an inner magnet structure and an outer magnet structure.

4. A coaxial speaker according to claim 1, wherein the hollow is communicated with the enclosed space via at least one passage formed through the components of the magnetic circuit.

5. A coaxial speaker according to claim 1, wherein the hollow is communicated with the enclosed space via at least one passage including a recess formed at an inner circumferential surface of the support member and a recess formed at an inner circumferential surface of the frame.

6. A coaxial speaker according to claim 1, wherein the support member has a cup-like configuration having an open end.

7. A coaxial speaker according to claim 6, wherein the support member and the frame are integrated as one piece such that the frame is integrally attached to the open end of the support member.

8. A coaxial speaker according to claim 1, wherein a wire housing portion extending in an axial direction for accommodating wires connecting between the woofer and the tweeter is provided inside the support member so as to be completely partitioned off from the hollow in order to keep the hollow hermetic.

9. A coaxial speaker according to claim 4, wherein the at least one passage is located in a center portion of the magnetic circuit.

10. A coaxial speaker according to claim 5, wherein the recess of the support and the recess of the frame are aligned along an axial direction.
